(19) United States
(12) Patent Application Publication
(10) Pub. No.: US 2006/0017890 A1
(43) Pub. Date: Jan. 26, 2006

(54) Image display method, image display apparatus, light scattering means, and image display program

(75) Inventor: Mitsuhiro Inazumi, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/184,977

(22) Filed: Jul. 20, 2005

(30) Foreign Application Priority Data
Jul. 23, 2004 (JP) 2004-215331

(51) Int. Cl. G03B 21/00

(52) U.S. Cl. 353/69

(57) ABSTRACT

An image display method of the exemplary embodiments, in which a projection image projected from an image projection device is scattered by a light scattering device, thereby displaying a display image on the light scattering device, the image display method includes: projecting a control image, which is used to correct the display image to be projected onto the light scattering device, from the image projection device toward the light scattering device; detecting the control image by a plurality of photodetection devices disposed outside an effective image display region on the light scattering device; generating an image correction signal, based on control image detection signals from the photodetection devices; and projecting onto the light scattering device the projection image corrected based on the image correction signal. A correction parameter, having accurately reflected thereon a distortion of the projection image, can be detected with accuracy, and a reduction in display image quality is discouraged or prevented from occurring due to the presence of the photodetection device.

### BACKGROUND

The exemplary embodiments relate to an image display method, image display apparatus, light scattering device, and image display program.

An image display apparatus of image projection type is known in the related art. The image display apparatus of image projection type has the feature that a degree of freedom in image display is very high as compared, for example, with an image display apparatus of direct view type using a plasma display panel or a liquid crystal panel.

In the case of the image display apparatus of direct view type, the size of a display screen is the very size of a display device, and the display device is manufactured using a large thin glass plate as a substrate. Therefore, it is not easy to freely change the size of the display screen.

In contrast, in the image display apparatus of image projection type, a projection image is obtained by transmitting or reflecting light through/from a small-sized electro-optical modulation device, e.g., a small-sized liquid crystal device or a micromirror type of light modulation device. The projection image is enlarged by a projection optical system and projected onto a light scattering device such as a screen, thereby making it possible to easily realize any size of screen. Further, the brightness of the display screen can also be changed with comparative ease by a light source.

Such a degree of freedom in image display is obtained because the light source, electro-optical modulation device, projection optical system, etc. are separated from each other. That is, combinations thereof make it possible to realize a considerable number of kinds of image display methods and image display apparatuses.

However, a high degree of freedom in image display sometimes causes a reduction in image quality. Particularly, distortion of the projection image is a form of reduction in display image quality which cannot occur in the image display apparatus of direct view type. This distortion of the projection image occurs when the image projection device, projection optical system, and light scattering device are not in proper positional relationship, or when the positional relationship therebetween varies.

As the method of correcting the distortion of the projection image projected from the image projection device and thus displaying the display image on the light scattering device, there is an image display method of correcting a projection image, using a imaging device (e.g., see JP-A-9-326981 and JP-A-2002-185987). The image display method disclosed in JP-A-9-326981 shows projection image correction formula (see Formula (2) to (4) and FIG. 2 of JP-A-9-326981), wherein a relative rotation angle about a projection axis between a screen serving as a light scattering device and a projector unit serving as an image projection device is indicated by ω, a vertical intersection angle between a projection image projected from a projector unit and a screen is indicated by θ, and a horizontal intersection angle between a projection image projected from the projector unit and the screen is indicated by φ. A digital camera serving as the imaging device is used to detect these three angles.

Furthermore, JP-A-9-326981 also discloses a display image method in which a large number of minute photodetection devices (optical sensors) are disposed inside an effective image display region on the screen, thereby comprehending how an image is projected on the screen.

An image display method disclosed in JP-A-2002-185987 is the method in which a digital camera serving as a imaging device is disposed opposite or parallel to a projector unit serving as an image projection device, thereby detecting distortion of a projection image projected from the projector unit, thus displaying on a screen, as a light scattering device, the projection image having the distortion corrected.

### SUMMARY

However, in the image display method described in JP-A-9-326981, there is a possibility that distortion occurs in the imaging device itself, and it is difficult to separate the distortion occurring in the imaging device from the distortion of the projection image. Further, since the positional relationship between the effective image display region on the light scattering device and the imaging device is not constant, a correction parameter for correcting the projection image cannot be detected with accuracy. Consequently, there is the problem in which the correction parameter having accurately reflected thereon the distortion of the projection image cannot be detected with accuracy.

Further, in the aforesaid image display method where the photodetection devices are disposed, the distortion of the projection image is configured to be detected by the photodetection devices disposed inside the effective image display region. Therefore, when a transmissive screen is used as the light scattering device, there is the problem in which a reduction in display image quality is likely to occur due to the presence of the photodetection devices. However, even when a reflective screen is used as the light scattering device, it is difficult to make the presence of the photodetection devices difficult to see, so that it is not easy to avoid the reduction in display image quality.

In the image display method described in JP-A-2002-185987, the effective image display region of the light scattering device and the position of the imaging device are fixed. Therefore, the problem resulting from their relative positional relationship has been solved, but the aforesaid problem of the distortion resulting from the imaging device itself remains unsolved.

Thereupon, the exemplary embodiments provide an image display method and an image display apparatus that can accurately detect a correction parameter having accurately reflected thereon distortion of a projection image and that prevent distortion of a display image from occurring due to the presence of a photodetection device, and a light scattering device and an image display program that are suitably used in such an image display apparatus.

(1) The image display method of the exemplary embodiments is an image display method in which a projection image projected from an image projection device is scattered by light scattering device, thereby displaying a display image on the light scattering device, the method comprising: projecting a control image, which is used to correct the display image to be projected onto the light scattering device, from the image projection device toward the light scattering device; detecting the control image by a plurality of photodetection device disposed outside an effective image display region on the light scattering device; generating an image correction signal, based on control image detection signals from the photodetection devices; and projecting onto the light scattering device the projection image corrected based on the image correction signal.

According to the image display method of the exemplary embodiments, the configuration is such as follows. That is, the control image is projected from the image projection device toward the light scattering device. The control image is detected by the plurality of photodetection devices disposed outside the effective image display region on the light scattering devices. And, the image correction signal is generated based on the control image detection signals from the photodetection device. Therefore, the image correction signal can be generated without using the imaging device. As a result, it is possible to address or solve the problem of distortion of the projection image resulting from the use of the imaging device and the problem of being unable to accurately detect the correction parameter having accurately reflected thereon the distortion of the projection image. This makes it possible to accurately detect the correction parameter having accurately reflected thereon the distortion of the projection image.

Further, the aforesaid plurality of photodetection devices are disposed outwardly of the effective image display region on the light scattering device. Therefore, even when any one of the transmissive and reflective screens is used, the reduction in display image quality will never occur, or will de discouraged from occurring, due to the presence of the photodetection device.

The light scattering device for use in the image display method of the exemplary embodiments need only be a light scattering device that displays the display image by scattering the projection image projected from the image projection device, and can suitably use, for example, a screen.

The image projection device for use in the image display method of the exemplary embodiments need only be an image projection device that projects the projection image in response to the display image data on the display image to be projected, and can suitably use, for example, a projector.

The photodetection device for use in the image display method of the exemplary embodiments can suitably use, for example, optical sensors.

(2) The image display method according to (1), further includes disposing the photodetection devices along the peripheral edge of the effective image display region.

By adopting such a method, the positions of the individual photodetection devices can be considered equivalent to the position of the peripheral edge of the effective image display region on the light scattering device. Consequently, the position of the effective image display region on the image formation region of the electro-optical modulation device can be easily obtained with high accuracy.

(3) The image display method according to (1) or (2), further includes disposing the photodetection devices in a plane with the light scattering device.

Adoption of such a method can facilitate the detection of image distortion.

(4) In an image display method according to any one of (1) to (3), the control image being a longitudinal linear image extending in a longitudinal direction and a lateral linear image extending in a lateral direction, the method further including: scanning the longitudinal linear image along the lateral direction of the light scattering device, and scanning the lateral linear image along the longitudinal direction of the light scattering device.

By adopting such a method, the actual positions of the photodetection device on the light scattering device can be accurately made to correspond to the hypothetical positions of the photodetection device on the image formation region of the electro-optical modulation device.

(5) The image display method according to any one of (1) to (3), further includes projecting the control image, which is a frame-like image, outside the effective image display region.

By adopting such a method, the control image is no longer projected within the effective image display region. Therefore, this makes it possible to detect, in real time, the distortion of the projection image resulting from displacement, etc. of the image projection device while projecting the projection image.

(6) The image display method according to (5), further including simultaneously projecting the control image and the display image.

Adoption of such a method makes it possible to perform an image correction in real time during the projection of the display image.

(7) The image display method according to (5) or (6), the detecting the control image including periodically changing, the size of the control image by a predetermined reference signal, and synchronously detecting and amplifying the control image detection signals and the predetermined reference signal, thereby amplifying only a component synchronous with the reference signal out of the control image detection signals, thus detecting the control image.

By adopting such a method, for example, even when light of the display image displayed on the effective image display region falls on the photodetection device as scattering light, the control image can be detected with good efficiency and high accuracy.

(8) The image display apparatus of the exemplary embodiments is an image display apparatus comprising: an image input device to input display image data on a display image to be projected; an image projection device that projects a projection image in response to the display image data inputted to the image input device; and a light scattering device that displays the display image by scattering the projection image projected from the image projection device; a control image generation device that generates control image data on a control image that is used to correct the display image to be projected; a plurality of photodetection devices that are disposed outside an effective image display region on the light scattering device; an image correction signal generation device that generates an image correction signal, based on control image detection signals from the photodetection devices; and an image correction device that corrects the display image to be projected onto the light scattering device, based on the image correction signal.

Consequently, according to the image display apparatus of the exemplary embodiments, the configuration is such as follows. That is, the control image generated by the control image generation device is detected by the plurality of devices disposed outside the effective image display region. And, the image correction signal generation device generates the image correction signal, based on the control image detection signals from the device. Therefore, the image correction signal can be generated without using the photographing device. As a result, the correction parameter having accurately reflected thereon the distortion of the projection image can be detected with accuracy.

Further, the aforesaid plurality of photodetection device are disposed outwardly of the effective image display region of the light scattering device. Therefore, the reduction in display image quality will never occur due to the presence of the photodetection device.

The image display apparatus of the exemplary embodiments also has a suitable feature in the aforesaid image display method.

(9) The image display apparatus according to (8), includes the image projection device including a plurality of image projection devices, the image correction device having a function of correcting the display images projected by the individual image projection devices.

Such a configuration makes it possible to obtain the effect described in (8) even in multi-projection display in which the projection images from the plurality of image projection devices are tiling-projected onto the light scattering device.

(10) The light scattering device of the exemplary embodiments is a light scattering device for use in the image display apparatus according to (8) or (9), the light scattering device including a plurality of photodetection devices outside the effective image display region.

Consequently, the image display apparatus is configured using the light scattering device and image projection devices of the exemplary embodiments, thereby making it possible to obtain the effect described in (8).

(11) An image display program embodied on a recording medium of the exemplary embodiments is for use with an image display apparatus, in which a projection image projected from image projection devices is scattered by a light scattering device, thereby displays a display image on the light scattering device, the program including: a program for projecting a control image, which is used to correct the display image to be projected onto the light scattering device, from the image projection devices toward the light scattering device; a program for detecting the control image by a plurality of photodetection devices disposed outside an effective image display region on the light scattering device; a program for generating an image correction signal, based on control image detection signals from the photodetection devices; and a program for projecting onto the light scattering device the projection image corrected based on the image correction signal.

The image display apparatus is operated using the image display program of the exemplary embodiments, thereby making it possible to obtain the same effect as that of the image display method according to (1).

The image display program of the exemplary embodiments also has a suitable feature in the aforesaid image display method.

### BRIEF DESCRIPTION OF THE DRAWINGS

FIG. 1 is a schematic of the configuration of an image display apparatus according to Exemplary Embodiment 1;

FIG. 2 is a schematic of the configuration of a light scattering device according to Exemplary Embodiment 1;

FIG. 3 is a schematic of individual positions of an effective image display region, a projectable region, and photodetection device, as made to correspond to the respective positions thereof on an image formation region of an electro-optical modulation device in an exemplary embodiment;

FIGS. 4A and 4B are schematics of a method in which lateral positions of an individual photodetection device on a light scattering device are made to correspond to the lateral positions thereof on the image formation region of the electro-optical modulation device in an exemplary embodiment;

FIGS. 5A and 5B are schematics of a method in which longitudinal positions of an individual photodetection device on a light scattering device is made to correspond to longitudinal positions thereof on an image formation region of an electro-optical modulation device in an exemplary embodiment;

FIG. 6 is a schematic of a method of obtaining a correction parameter to correct distortion of a display image to be projected onto an effective image display region in an exemplary embodiment;

FIG. 7 is a schematic of a method of obtaining a correction parameter to correct distortion of a display image to be projected onto an effective image display region in an exemplary embodiment;

FIG. 8 is a flowchart of an image correction process that is used in an image display method according to Exemplary Embodiment 1;

FIG. 9 is a schematic of a configuration of an image display apparatus according to Exemplary Embodiment 2;

FIG. 10 is a schematic of tiling projection onto a light scattering device by way of a plurality of image projection devices in an exemplary embodiment;

FIG. 11 is a schematic of the image projection device opposite a light scattering device in an exemplary embodiment;

FIG. 12 is a schematic of the image projection device inclined at a tilt angle φ to a position thereof opposite a light scattering device in an exemplary embodiment;

FIG. 13 is a schematic of the ratio of the distances between the optical axis of an image projection device and both ends of an effective image display region, as a function of the angle φ, a projected angle θ being set to 60° in an exemplary embodiment;

FIGS. 14A and 14B are schematics of the state in which the image formation region of the electro-optical modulation device rotates by a rotation angle φ about a y-axis relative to the light scattering device in an exemplary embodiment;

FIG. 15 is a schematic of the state in which the image formation region of the electro-optical modulation device rotates by a rotation angle φ1 about the y-axis and by a rotation angle φ2 about an x-axis, relative to the light scattering device in an exemplary embodiment;

FIG. 16 is a schematic illustrating obtaining the rotation angle of a side, which has an arbitrary direction, of the effective image display region on the image formation region of the electro-optical modulation device in an exemplary embodiment;

FIGS. 17A-17C are schematics of the method of obtaining the coordinates of the remaining one vertex of the effective image display region on the image formation region of the electro-optical modulation device of one of the image projection devices in an exemplary embodiment;

FIG. 18 is a schematic flowchart of a procedure of an image correction process that is used in the image display method according to a second exemplary embodiment;

FIG. 19 is a schematic of the configuration of an image display apparatus according to a third exemplary embodiment;

FIGS. 20A and 20B are schematics of a projection image as projected on a light scattering device in an exemplary embodiment;

FIG. 21 is a schematic of an image display apparatus according to a fourth exemplary embodiment;

FIGS. 22A-22C are schematics of an image display method according to the fourth exemplary embodiment;

FIG. 23 is a schematic of a reference signal for use in the image display method according to the fourth exemplary embodiment;

FIG. 24 is a schematic of the situation in which scattering light from a projection image is detected in the photodetection device as superimposed on a frame-image in an exemplary embodiment;

FIG. 25 is a schematic of the operation of amplifying a specific frequency signal on a frequency scale in an exemplary embodiment; and

FIGS. 26A-26C are schematics of the principle of measuring the position of a photodectection device, based on the operation of a lock-in amplification device in an exemplary embodiment.

### DETAILED DESCRIPTION OF EMBODIMENTS

An image display method, image display apparatus, a light scattering device, and an image display program embodied on a recordable medium will hereinafter be described with reference to illustrated exemplary embodiments.

### Exemplary Embodiment 1

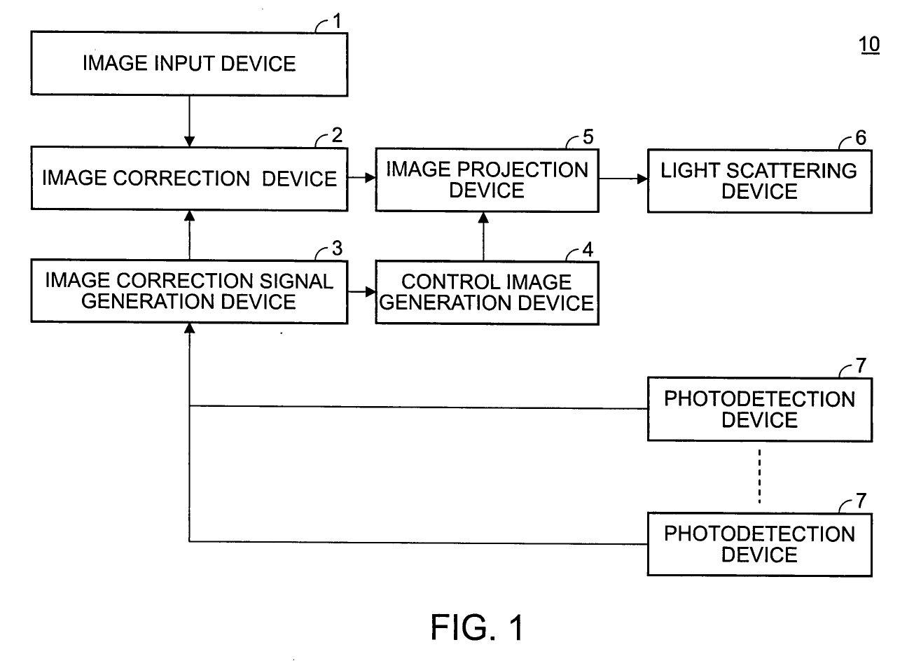

FIG. 1 is a schematic of the configuration of an image display apparatus 10 according to Exemplary Embodiment 1.

As shown in FIG. 1, the image display apparatus 10 of Exemplary Embodiment 1 includes an image input device 1, an image projection device 5, and a light scattering device 6. The image input device 1 is for inputting display image data on a display image to be projected. The image projection device 5 projects a projection image in response to the display image data inputted to the image input device 1. And, the light scattering device 6 displays the display image by scattering the projection image projected from the image projection device 5.

The image projection device 5 has an electro-optical modulation device for modulating light from a light source in response to the display image data and thus generating image light. The electro-optical modulation device can suitably use a transmissive or reflective liquid crystal device or a micromirror type of light modulation device. Further, the light scattering device 6 can suitably use a transmissive or reflective screen.

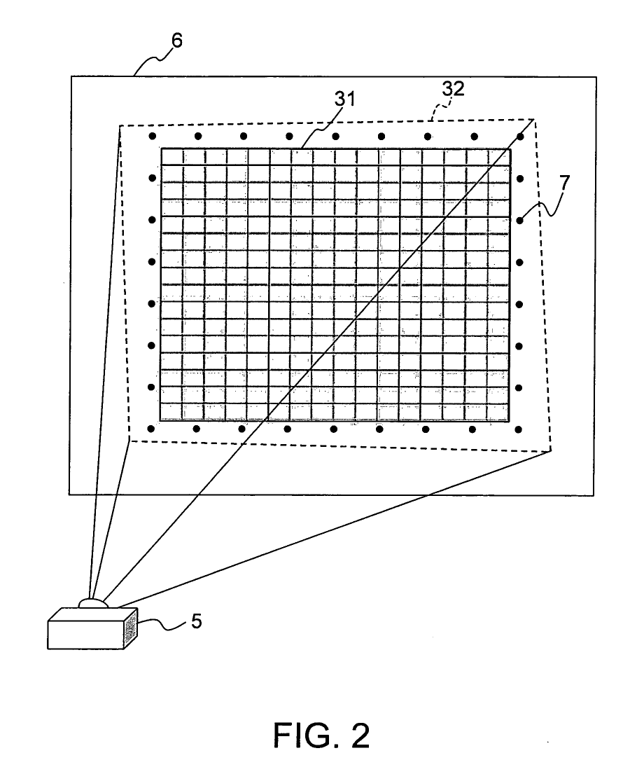

Further, the image display apparatus 10 of Exemplary Embodiment 1 further includes a control image generation device 4, a plurality of photodetection devices 7, an image correction signal generation device 3, and an image correction device 2. The control image generation device 4 generates control image data on a control image that is used to correct the display image to be projected. The plurality of photodetection devices 7 are disposed outside an effective image display region 31 (see FIG. 2 to be described later) on the light scattering device 6. The image correction signal generation device 3 generates an image correction signal, based on control image detection signals from the photodetection devices 7. And, the image correction device 2 corrects the display image to be projected onto the light scattering device 6, based on the image correction signal. The photodetection devices 7 are zero-dimensional photodetection devices.

An image display operation of the thus-configured image display apparatus 10 will be briefly described.

First, the image correction device 2 corrects distortion, etc. of the display image data inputted to the image input device 1. Simultaneously therewith or separately therefrom, the control image generation device 4 generates the control image data on the control image that is used to correct the display image to be projected. And, the projection image responsive to the display image data and the control image responsive to the control image data are simultaneously or separately projected from the image projection device 5 toward the light scattering device 6. The display image data corrected by the image correction mans 2 provides the projection image to be provided to an audience.

Next, when the photodetection devices 7 detect the control image, the image correction signal generation device 3 generates the image correction signal, based on the control image detection signals from the photodetection devices 7. The image correction device 2 corrects the display image to be projected onto the light scattering device 6, based on the image correction signal generated by the image correction signal generation device 3.

FIG. 2 is a schematic of the light scattering device 6 according to Exemplary Embodiment 1. FIG. 2 illustrates the case in which the image projection device 5 is disposed so as to project the projection image from the diagonally left direction of the light scattering device 6. Additionally, for brevity of description, Exemplary Embodiment 1 shows an example in which the photodetection devices 7 are disposed substantially in plane with the projection plane of the light scattering device 6.

As shown in FIG. 2, on the light scattering device 6 of Exemplary Embodiment 1, the plurality of photodetection devices 7 are disposed outside the effective image display region 31 thereon onto which the image projection device 5 projects and inside a region (hereinafter called a projectable region) 32 thereon onto which the image projection device 5 can project.

Here, the positional relationship between the effective image display region 31 and the plurality of photodetection devices 7 is fixed. This makes it possible to estimate the position of the effective image display region 31 with sufficient accuracy, based on the positions of the photodetection devices 7.

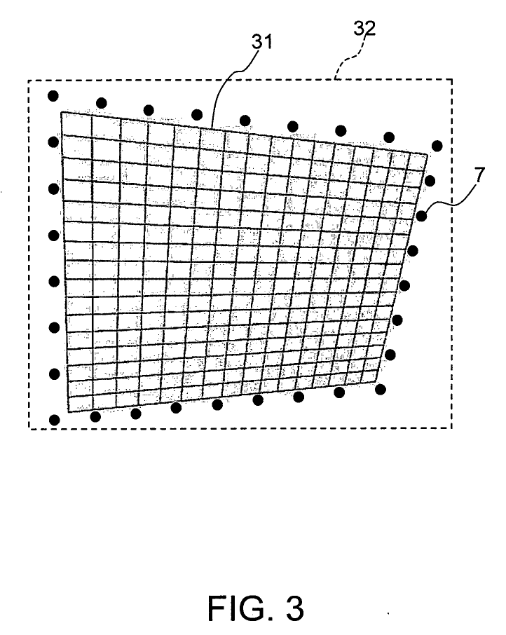

FIG. 3 is a schematic of the individual positions of the effective image display region 31, projectable region 32, and the photodetection devices 7, as made to correspond to the respective positions thereof on an image formation region of the electro-optical modulation device.

When the position of the effective image display region 31 (see FIG. 2), which is formed into a rectangle on the light scattering device 6, is made to correspond to the position thereof on the image formation region of the electro-optical modulation device, as shown in FIG. 3, the effective image display region 32 is not formed into a rectangle on the image formation region of the electro-optical modulation device. The reason is that the image projection device 5 is disposed at an angle to the light scattering device 6 as shown in FIG. 2. Similarly, the positions of the individual photodetection devices 7 are also located as shown in FIG. 3 when made to correspond to the positions thereof on the image formation region of the electro-optical modulation device.

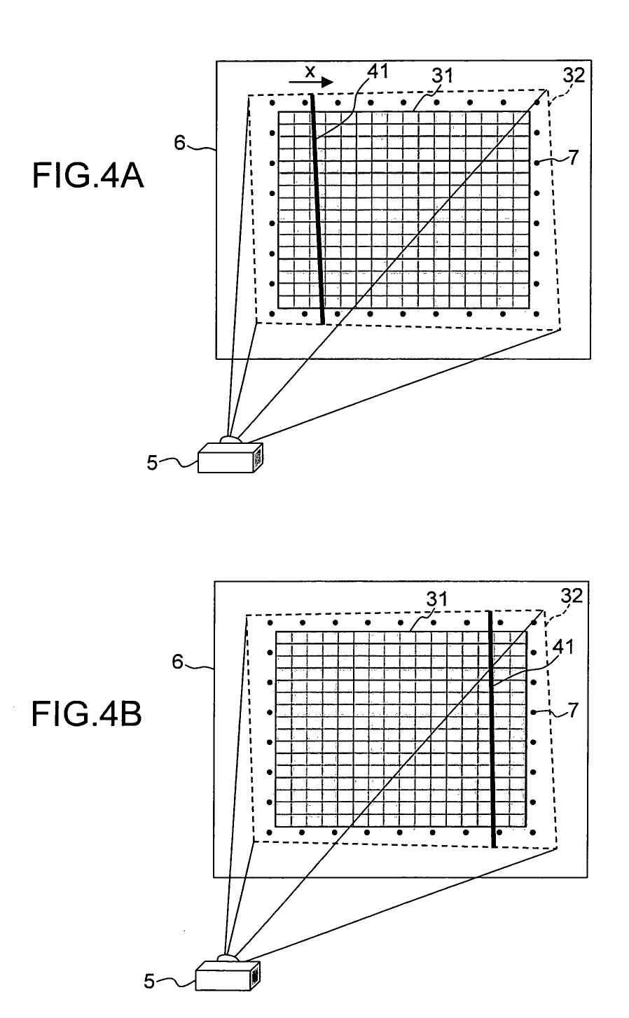

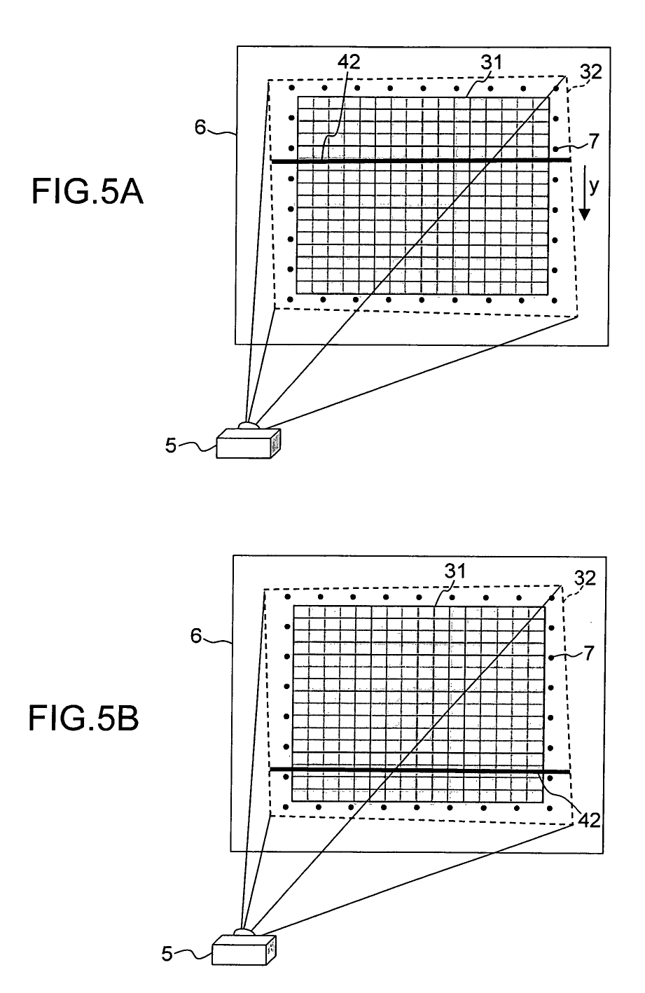

Here, in the image display method of Exemplary Embodiment 1, an example of the method, in which the longitudinal and lateral positions of the individual photodetection devices 7 on the light scattering device 6 are made to correspond to the respective longitudinal and lateral positions thereof on the image formation region of the electro-optical modulation device, will be described using FIGS. 4A, 4B, 5A and 5B.

FIGS. 4A and 4B are schematics of the method in which the lateral positions of the individual photodetection devices 7 on the light scattering device 6 are made to correspond to the lateral positions thereof on the image formation region of the electro-optical modulation device. FIGS. 5A and 5B are schematics of the method in which the longitudinal positions of the individual photodetection devices 7 on the light scattering device 6 are made to correspond to the longitudinal positions thereof on the image formation region of the electro-optical modulation device.

In the image display method of Exemplary Embodiment 1, the configuration is such that a longitudinal linear image 41 extending in a longitudinal direction and a lateral linear image 42 extending in a lateral direction are used as the control image that is used to correct the display image to be projected onto the light scattering device 6.

First, as shown in FIGS. 4A and 4B, out of lines configuring the longitudinal direction on the image formation region of the electro-optical modulation device, one line (the longitudinal linear image 41) represented by a bright or dark line is scanned in the lateral direction (x direction in FIG. 4A). That is, as shown in FIGS. 4A and 4B, the longitudinal linear image 41 is scanned to detect at which position of the longitudinal linear image 41 the photodetection devices 7 react. Thereby, the lateral positions of the individual photodetection devices 7 on the light scattering device 6 can be made to correspond to the lateral positions thereof on the image formation region of the electro-optical modulation device.

And, as shown in FIGS. 5A and 5B, out of lines configuring the lateral direction on the image formation region of the electro-optical modulation device, one line (the lateral linear image 42) represented by a bright or dark line is scanned in the longitudinal direction (y direction in FIG. 5A). That is, as shown in FIGS. 5A and 5B, the lateral linear image 42 is scanned to detect at which position of the lateral linear image 42 the photodetection devices 7 react. Thereby, the longitudinal positions of the individual photodetection devices 7 on the light scattering device 6 can be made to correspond to the longitudinal positions thereof on the image formation region of the electro-optical modulation device.

Thus, the longitudinal linear image 41 is scanned in the lateral direction, and the lateral linear image 42 is scanned in the longitudinal direction. Thereby, it is possible to know the positions (x coordinates and y coordinates) of the individual photographic devices 7 on the image formation region of the electro-optical modulation device which correspond to the positions of the individual photodetection devices 7 on the light scattering device 6.

In the image display method of Exemplary Embodiment 1, the description has been given thereof by illustrating the method in which the control image is scanned all over the projectable region 32 on the light scattering device 6 when the photodetection devices 7 detect the control image. However, when the positions of the photodetection devices 7 can be estimated, it is only necessary to scan the vicinity of the estimated positions. In this case, it is also possible to scan only the outside of the effective image display region 31.

In the image display method of Exemplary Embodiment 1, the positional relationship between the photodetection devices 7 and effective image display region 31 on the light scattering device 6 can be assumed to be known without losing generality. For example, in the image display method of Exemplary Embodiment 1, the photodetection devices 7 are disposed along the effective image display region 31.

By so doing, as aforesaid,, the longitudinal linear image 41 is scanned in the lateral direction, and the lateral linear image 42 is scanned in the longitudinal direction. Thereby, it is possible to know the positions of the individual photodetection devices 7 on the image formation region of the electro-optical modulation device which correspond to the positions of the individual photodetection devices 7 on the light scattering device 6. Therefore, this makes it possible to estimate with sufficient accuracy even the position of the effective image display region 31 on the image formation region of the electro-optical modulation device which corresponds to the position of the effective image display region 31 on the light scattering device 6. Consequently, in the following description, the estimation of the positions of the photodetection devices 7 is considered equivalent to the estimation of the position of the effective image display device 31 on the image formation region of the electro-optical modulation device.

Accordingly, once the position of the effective image display region 31 on the image formation region of the electro-optical modulation device is determined, it becomes possible to obtain a correction parameter for correcting the distortion of the display image to be projected onto the effective image display region 31 on the light scattering device 6.

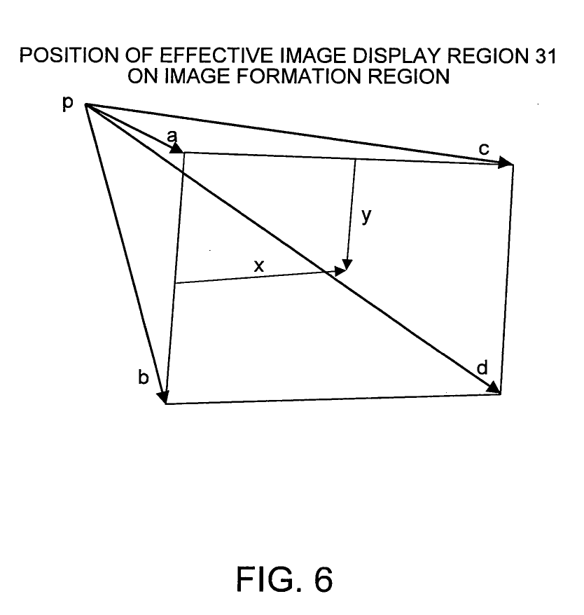

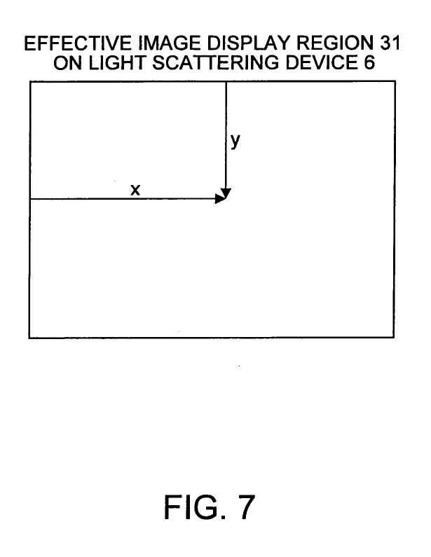

FIGS. 6 and 7 are schematics of the method of obtaining the correction parameter for correcting the distortion of the display image to be projected onto the effective image display region 31. In FIG. 6, an arbitrary point p is set to serve as an origin, and the positions of four corners of the effective image display region 31 on the image formation region of the electro-optical modulation device are indicated by a, b, c, and d. Further, in FIG. 7, the coordinates of a point in the effective image display region 31 on the light scattering device 6 are indicated by coordinates (x, y) and, for brevity of description, the range of x and y values is normalized to be between 0 and 1 in their respective longitudinal and lateral directions.

The coordinates (x, y) of the point shown in FIG. 7 in the effective image display region 31 on the light scattering device 6 correspond to such positions as shown in FIG. 6, on the image formation region of the electro-optical modulation device.

On this occasion, on the image formation region of the electro-optical modulation device, as shown in FIG. 6, the position vectors of the positions corresponding to the four corners of the effective image display region 31 are indicated by a, b, c, and d. Then, the coordinates thereof on the image formation region of the electro-optical modulation device, which correspond to the coordinates (x, y) of the point in the effective image display region 31 on the light scattering device 6, will be given by:
xy(d−c−b+a)+x(c−a)+y(b−a)+a (1).

That is, the coordinates of each point in the effective image display region 31 on the light scattering device 6 are converted, by use of this expression (1), to the coordinates thereof on the image formation region of the electro-optical modulation device. And, the correction parameter (image correction signal) is generated based on the converted coordinates to correct the display image to be projected onto the light scattering device 6. Thereby, it becomes possible to display the display image having no distortion in the effective image display region 31 on the light scattering device 6. However, in this expression (1), linearization is performed supposing that the distortion is small.

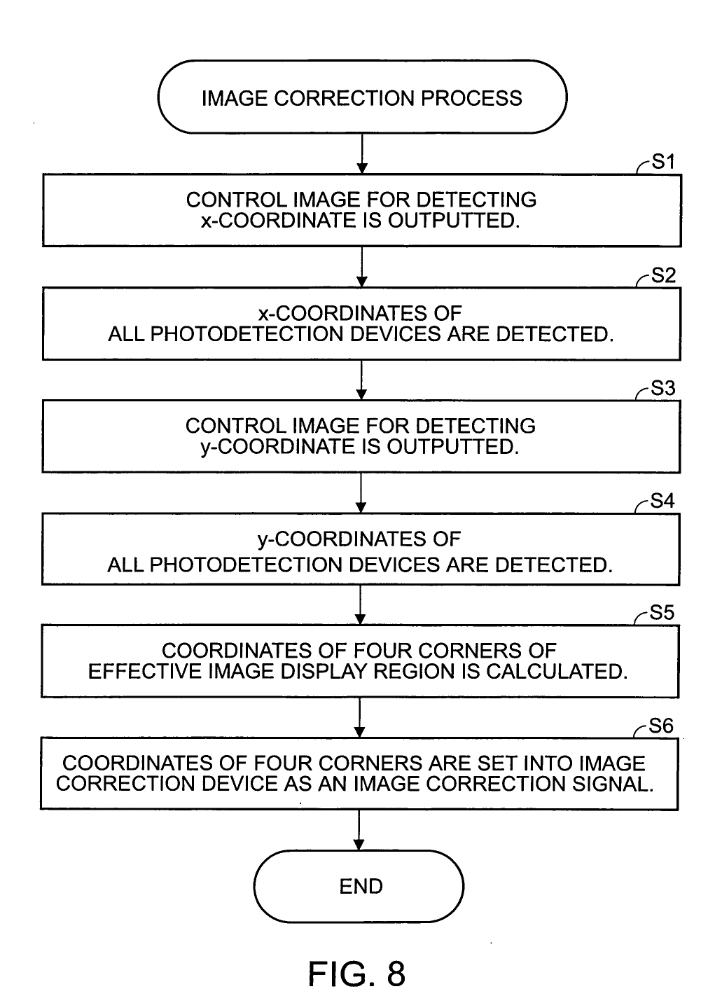

FIG. 8 is a flowchart showing the procedure of an image correction process for use in the image display method of Exemplary Embodiment 1. In the procedure of the image correction process for use in the image display method of Exemplary Embodiment 1, as shown in FIG. 8, the control image for x-coordinate detection is outputted (step S1). As already described, this is the operation of scanning the longitudinal linear image 41 in the lateral direction. The x-coordinates of all the photodetection devices 7 are detected by this operation (step S2). Similarly, the control image for y-coordinate detection is outputted (step S3). This is the operation of scanning the lateral linear image 42 in the longitudinal direction. The y-coordinates of all the photodetection devices 7 are detected by this operation (step S4). The coordinates of the four corners of the effective image display region 31 on the image formation region of the electro-optical modulation device are calculated based on the thus-detected x- and y-coordinates of all the photodetection devices 7 (step S5). And, the calculated coordinates of the four corners of the effective image display region 31 are set into the image correction device 2 as the image correction signal (step S6).

As described above, according to the image display method of Exemplary Embodiment 1, the configuration is such as follows. That is, the control image (longitudinal linear image 41 and lateral linear image 42) is projected from the image projection device 5 toward the light scattering device 6. The control image is detected by the plurality of photodetection devices 7 disposed outside the effective image display region 31 on the light scattering device 6. And, the image correction signal is generated based on the control image detection signals from the photodetection devices 7. Therefore, the image correction signal can be generated without using photographing devices. As a result, it is possible to solve the problem of distortion of the projection image resulting from the use of the photographing devices and the problem of being unable to accurately detect the correction parameter having accurately reflected thereon the distortion of the projection image. Thus, the correction parameter having accurately reflected thereon the distortion of the projection image can be detected with accuracy.

Further, the aforesaid plurality of photodetection devices 7 are disposed outwardly of the effective image display region 31 on the light scattering device 6. Therefore, even when any one of the transmissive and reflective screens is used, a reduction in display image quality will never occur due to the presence of the photodetection devices.

### Exemplary Embodiment 2

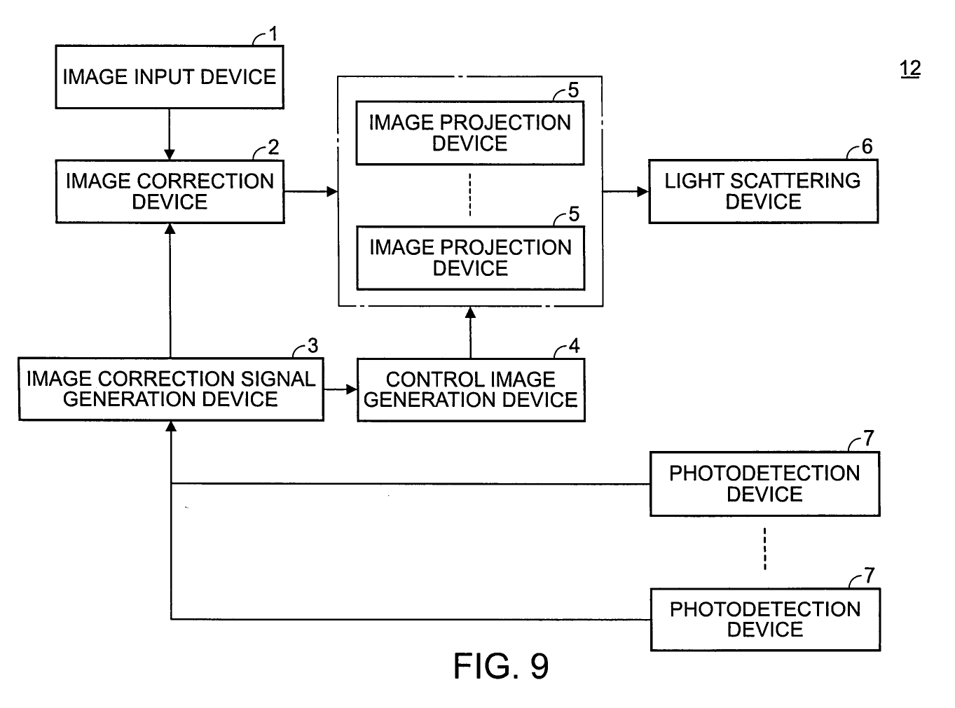

FIG. 9 is a schematic of an image display apparatus 12 according to Exemplary Embodiment 2. In FIG. 9, the same members as those of FIG. 1 are identified by like reference numerals and thus omitted from the detailed description.

As shown in FIG. 9, the image display apparatus 12 of Exemplary Embodiment 2 is different from the image display apparatus 10 of Exemplary Embodiment 1 in that it uses a plurality of image projection devices 5, but the other components thereof are the same as those of the image display apparatus 10 of Exemplary Embodiment 1.

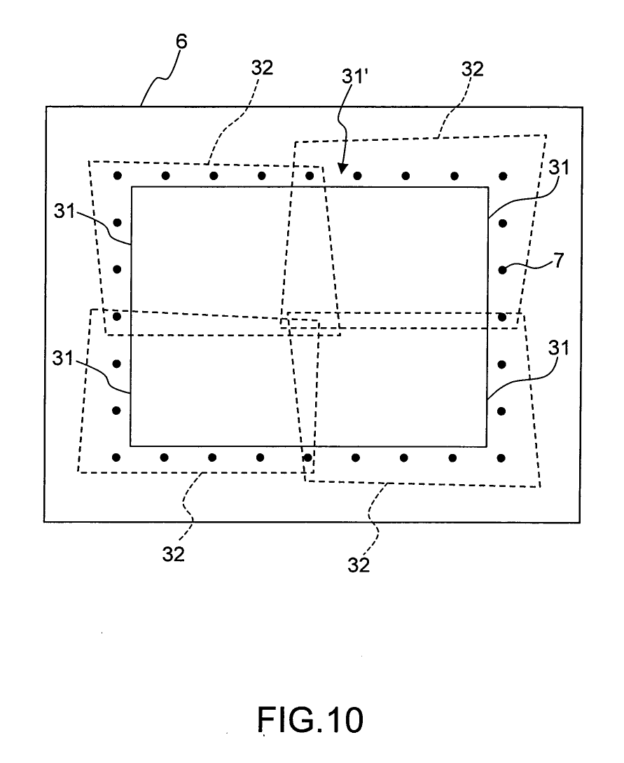

FIG. 10 is a schematic showing an example of tiling projection onto light scattering device 6 by way of the plurality of image projection devices 5. In FIG. 10, an effective image display region 31′ on the light scattering device 6 represents a total of effective image display regions onto which four image projection devices 5 project, and the entire effective image display region 31′ is formed by the effective image display regions 31 of the individual image projection devices 5.

In the image display apparatus 12 of Exemplary Embodiment 2, as shown in FIG. 10, projection images are tiling-projected from two-by-two, i.e., a total of four image projection devices 5, thereby making it possible to increase the total number of display pixels by substantially four times and increase the brightness of the entire display region by substantially four times.

As is apparent from FIG. 10, the image display method of Exemplary Embodiment 2 is different from that of Exemplary Embodiment 1 in that only the positions of two sides of each of the effective image display regions 31 of the individual image projection devices 5 can be estimated based on the outputs of the photodetection devices 7. As described in the image display method of Exemplary Embodiment 1, to correct the projection image projected from the image projection devices 5, there are required the coordinates of the positions of four corners (hereinafter sometimes called vertices) of the effective image display region 31 thereof.

In the image display method of Exemplary Embodiment 2, only the coordinates of three vertices of the effective image display region 31 of each of the individual image projection devices 5 can be directly obtained, and therefore it follows that no image correction signal can be obtained. Actually, however, it is possible to calculate the coordinates of the remaining one vertex from these three vertices and, even in the image display method of Exemplary Embodiment 2, it is possible to obtain the image correction signal. The image display method of Exemplary Embodiment 2 will hereinafter be described in detail.

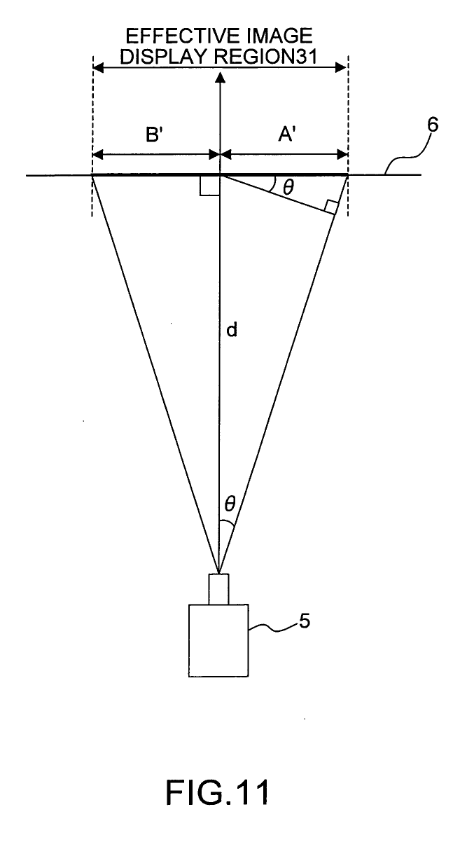

FIG. 11 is a schematic of the image projection devices 5 opposite the light scattering device 6. θ indicates the projected angle of an image. Additionally, in FIG. 11, for brevity of description, it is supposed that an optical axis matches the center point of the effective image display region.

In the example shown in FIG. 11, projection by the image projection devices 5 is symmetrical in the left/right direction of FIG. 11, and a distance A′ from the optical axis of the image projection devices 5 to the left end of the effective image display region 31 on the light scattering device 6 can be obtained from:
A′=d×sin(θ)/cos(θ) (2).
A distance B′ from the optical axis of the image projection devices 5 to the right end of the effective image display region 31 on the light scattering device 6 can also be similarly obtained. Accordingly, the ratio of the distance B′ to the distance A′ (=B′/A′) turns out to be 1.

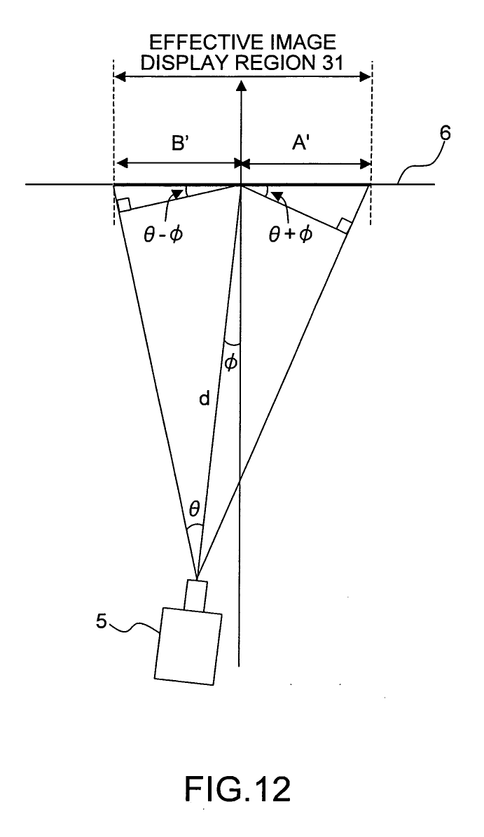

FIG. 12 is a schematic of the image projection devices 5 inclined at an angle φ to the position thereof opposite the light scattering device 6. Additionally, in FIG. 2 as well, similar to FIG. 11, it is supposed that the optical axis matches the center point of the effective image display region. In the example shown in FIG. 12, the length of A′ becomes longer than the length of B′, and A′ and B′ turn out to be:
A′=d×sin(θ)/cos(θ+φ) (3)
and
B′=d×sin(θ)/cos(θ−φ) (4),
respectively. Accordingly, in this case, the ratio of the distance B′ to the distance A′ (=B′/A′) turns out to be:
B′/A′=cos(θ+φ)/cos(θ−φ),
and becomes smaller than 1. This ratio of the distance B′ to the distance A′ (=B′/A′) is uniquely determined as a function of the angle φ and the projected angle θ.

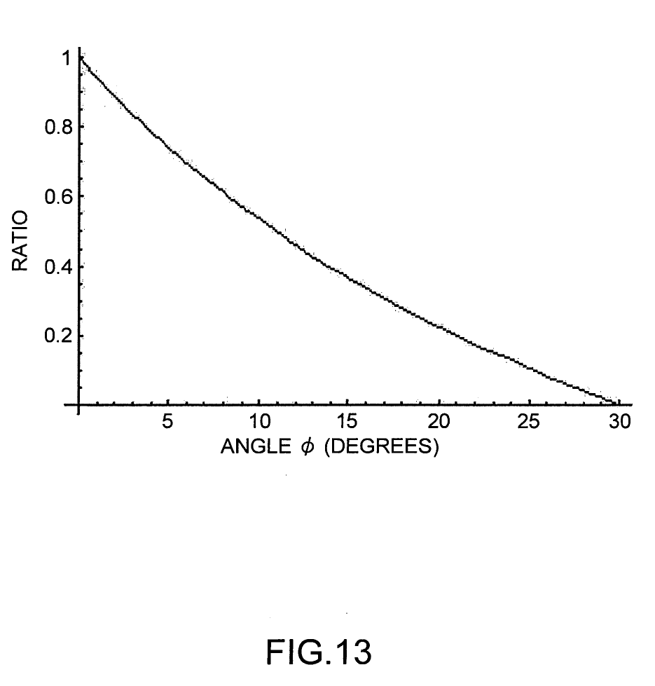

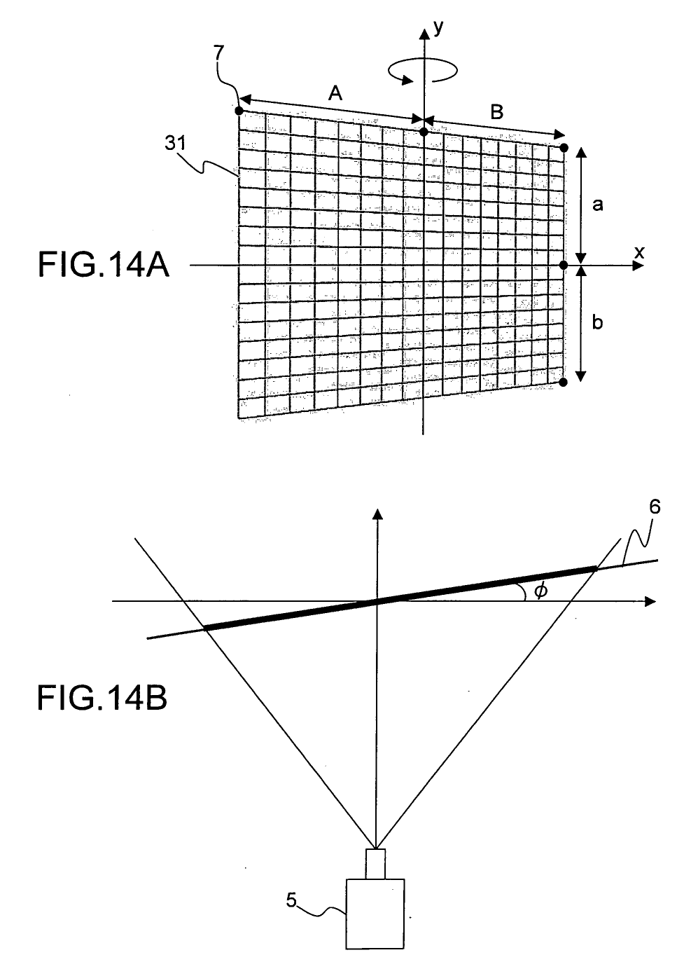

FIG. 13 is a schematic of, as a function of the angle φ, the ratio of the distances between the optical axis of the image projection devices 5 and both ends of the effective image display region 31 on the light scattering device 6, the projected angle θ being set to 60°. What is important here is that the projected angle θ is known and that the angle φ (hereinafter called the rotation angle φ) is uniquely determined when the value of the ratio of the distance B to the distance A (=B/A) is given. FIGS. 14A and 14B are for illustrating such importance.

FIGS. 14A and 14B are schematics of the state in which the image formation region of the electro-optical modulation device rotates by the rotation angle φ about a y-axis relative to the light scattering device 6. FIG. 14A is a schematic of the position of the effective image display region on the image formation region of the electro-optical modulation device. And, FIG. 14B is a top view schematic of the state in which the image formation region of the electro-optical modulation device rotates by the rotation angle φ about the y-axis relative to the light scattering device 6.

Here, it is supposed that the positions of the photodetection devices 7 (shown by black points in FIG. 14A) are detected as such positions as shown in FIG. 14A on the image formation region of the electro-optical modulation device.

On this occasion, the positions of the center point and both ends of each side of the effective image display region 31 on the image formation region of the electro-optical modulation device can be determined from the positions of the individual photodetection devices 7 on the image formation region of the electro-optical modulation device which correspond to the positions of the individual photodetection devices 7 on the light scattering device 6. Once the positions of the center point and both ends of each side of the effective image display region 31 on the image formation region of the electro-optical modulation device are known, the ratio of a distance B to a distance A (=B/A) can be obtained. Thus, it becomes possible to obtain the rotation angle φ, based on the relationship shown in FIG. 13, using the value of the obtained ratio of the distance B to the distance A (=B/A).

Similarly, it is also possible to obtain the ratio of a distance b to a distance a (=b/a) on the effective image display region 31 of FIG. 14A. In an example shown in FIGS. 14A and 14B, the value of this ratio of the distance b to the distance a (=b/a) is 1, and the rotation angle of an x-axis in this case turns out to be 0.

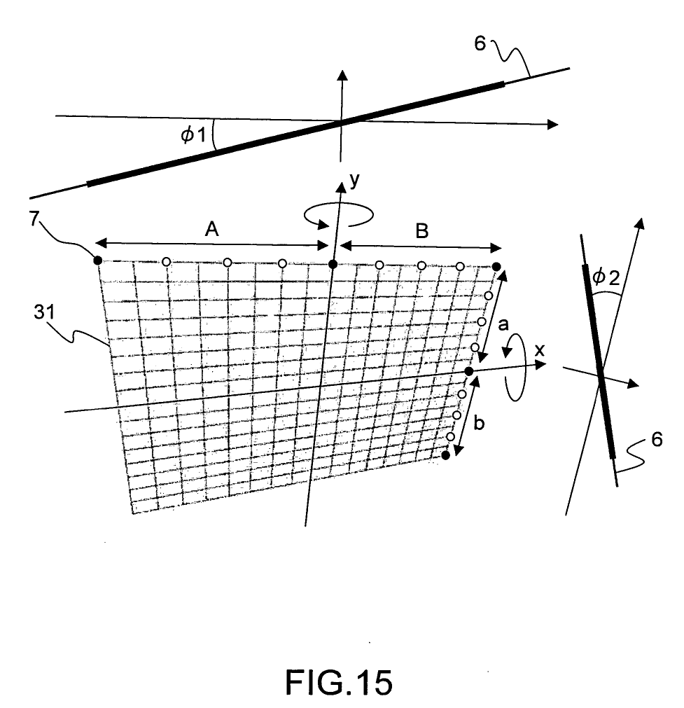

FIG. 15 is a schematic of the state in which the image formation region of the electro-optical modulation device rotates by a rotation angle φ1 about the y-axis and by a rotation angle φ2 about the x-axis, relative to the light scattering device 6. In the case of FIG. 15, as with the case of FIGS. 14A and 14B, as for each side of the effective image display region 31 on the image formation region of the electro-optical modulation device, the ratio of the distance B to the distance A (=B/A) and the ratio of the distance b to the distance a (=b/a) are obtained, thereby making it possible to obtain the rotation angles φ1 and φ2 of the respective two axes (x- and y-axes).

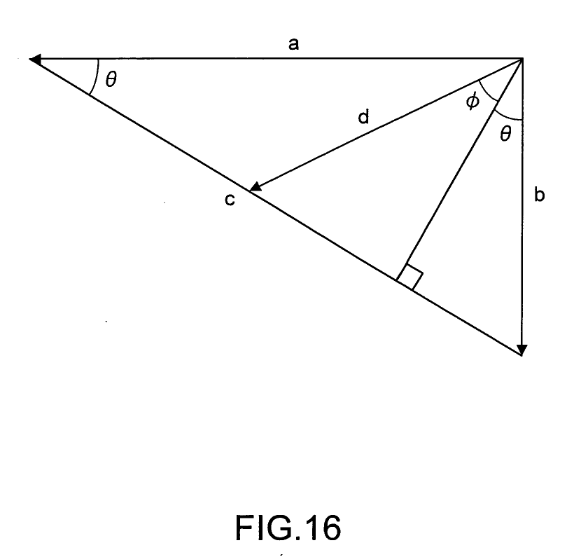

This makes it possible to obtain the rotation angle of a side, which has an arbitrary direction, of the effective image display region 31 on the image formation region of the electro-optical modulation device. FIG. 16 is a schematic showing that it becomes possible to obtain the rotation angle of the side, which has the arbitrary direction, of the effective image display region 31 on the image formation region of the electro-optical modulation device.

In FIG. 16, suppose that
a=tan(φ1) (5)
and
b=tan(φ2) (6).
Further, as shown in FIG. 16, a right triangle formed by a and b is figured, wherein an arbitrary point on the hypotenuse of this right triangle is indicated by c and the distance from the origin to the point c is indicated by d. Then, when the rotation angle in a direction from the origin to the point c is indicated by ω, ω is given by the following expression:
ω=arctan(a×sin(θ)/cos(φ)) (7).

For example, when the point c matches the direction of b, φ=−θ is obtained, and the expression (7) turns out to be:
ω=arctan(a×tan(θ)) (8).
Here, as is apparent from FIG. 16,
tan(θ)=b/a (9).
Therefore, the expression (8) turns out to be:
ω=arctan(b) (10).
That is, ω=φ2 is obtained from the expression (6).

Similarly, when the point c matches the direction a, ω=φ1 is obtained, so that a self-evident result can be obtained.

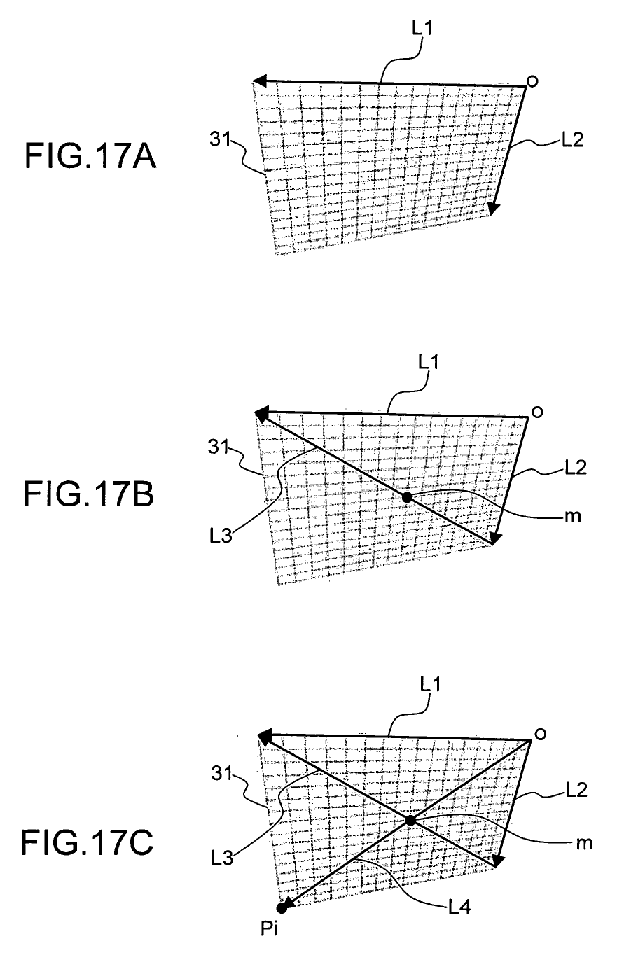

The method of obtaining, by use of the aforesaid, the coordinates of the remaining one vertex of the effective image display region 31 on the image formation region of the electro-optical modulation device of each of the image projection devices 5 will be described using FIGS. 17A-17C.

FIGS. 17A-17C are schematics of a method of obtaining the coordinates of the remaining one vertex of the effective image display region 31 on the image formation region of the electro-optical modulation device of one of the image projection devices 5.

First, it is supposed that the positions of the individual photodetection devices 7 on the image formation region of the electro-optical modulation device, which correspond to the positions of the individual photodetection devices 7 on the light scattering device 6, have been obtained by the method described in the image display method of Exemplary Embodiment 1. Here, out of the entire effective image display region 31′ (see FIG. 10) on the light scattering device 6, the image projection devices 5 in charge of the upper right effective image display region 31 is given as an example. As aforesaid, it is possible to obtain the values of the rotation angles of two sides L1 and L2 shown in FIG. 17A.

Next, as shown in FIG. 17B a diagonal line L3 connecting the two sides L1 and L2 is obtained. As aforesaid, it is possible to obtain the value of the rotation angle of this diagonal line L3. Once the rotation angle of the diagonal line L3 is determined, a center point m of the diagonal line L3 can be determined. The reason is that the ratio of the lengths on both sides of the center point m is determined once the rotation angle is determined, as described in the description of FIG. 13.

Thereby, as shown in FIG. 17C, a line segment passing through the center point m from an origin O of the two sides L1 and L2 provides a diagonal line L4 that determines the direction of the remaining one vertex. At the same time, it becomes possible to obtain even the rotation angle of this diagonal line L4. Once the rotation angle of the diagonal line L4 is determined, a position Pi of the tip of the diagonal line L4 can be obtained based on a ratio determined from this rotation angle. Thus, the position Pi provides a fourth vertex position to be obtained.

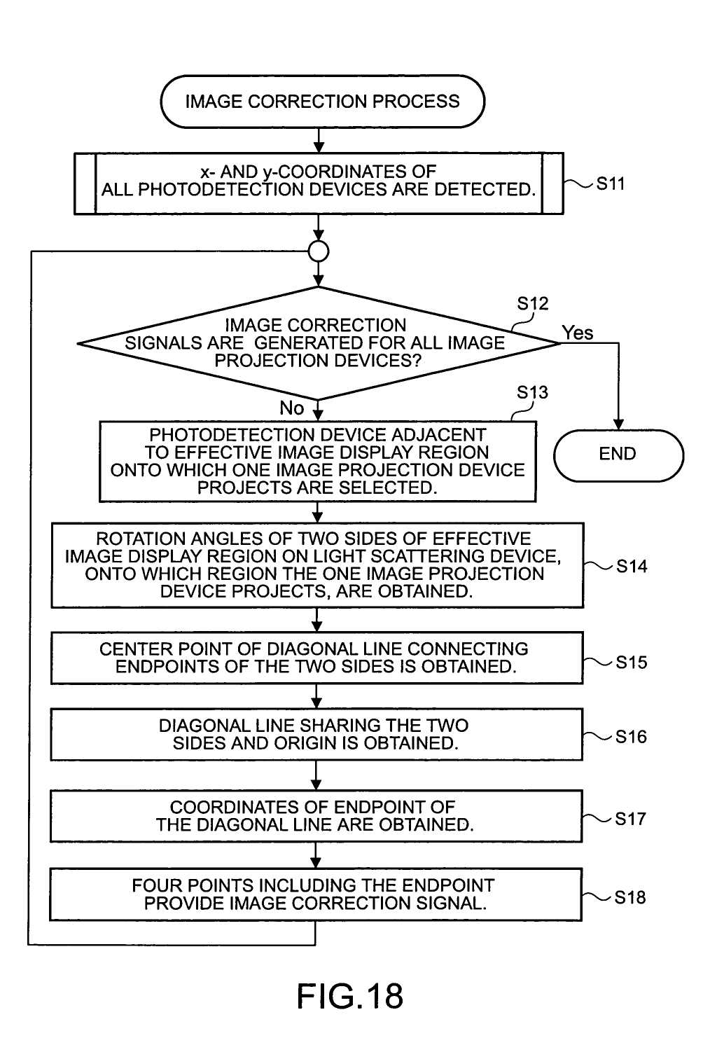

FIG. 18 is a flowchart showing the procedure of an image correction process for use in the image display method according to Exemplary Embodiment 2. In the procedure of the image correction process for use in the image display method of Exemplary Embodiment 2, as shown in FIG. 18, first, the x- and y-coordinates of all the photodetection devices 7 are detected (step S11). And, it is determined whether or not the image correction signals have been generated for all the image projection devices 5 (step S12). If the image correction signals have been generated for all the image projection devices 5, then the process is put to an end.

In the step S12, if the image correction signals have not been generated for all the image projection devices 5, then the photodetection devices 7 adjacent to the effective image display region 31 of the image projection devices 5 to be subjected to the process are selected (step S13). The rotation angles of two sides of the effective image display region on the image formation region of the electro-optical modulation device of the selected image projection devices 5 are obtained (step S14). The center point of the diagonal line connecting the endpoints of the obtained two sides is obtained (step S15). And, a diagonal line sharing the two sides and the starting point (origin) thereof is obtained (step S16). The coordinates of the endpoint of the obtained diagonal line are obtained (step S17). The coordinates of four points including the obtained endpoint provide the image correction signal (step S18).

The same process is also performed to the remaining three image projection devices 5, thereby making it possible to obtain the positions (coordinates) of four vertices of the effective image display region of each of the four image projection devices 5 of the image display apparatus 12. Thus, as with the case of the image display method of Exemplary Embodiment 1, the aforesaid positions (coordinates) can be given to the image correction device 2 as the image correction signals. This makes it possible to correct the projection images to be projected by the individual image projection devices 5.

### Exemplary Embodiment 3

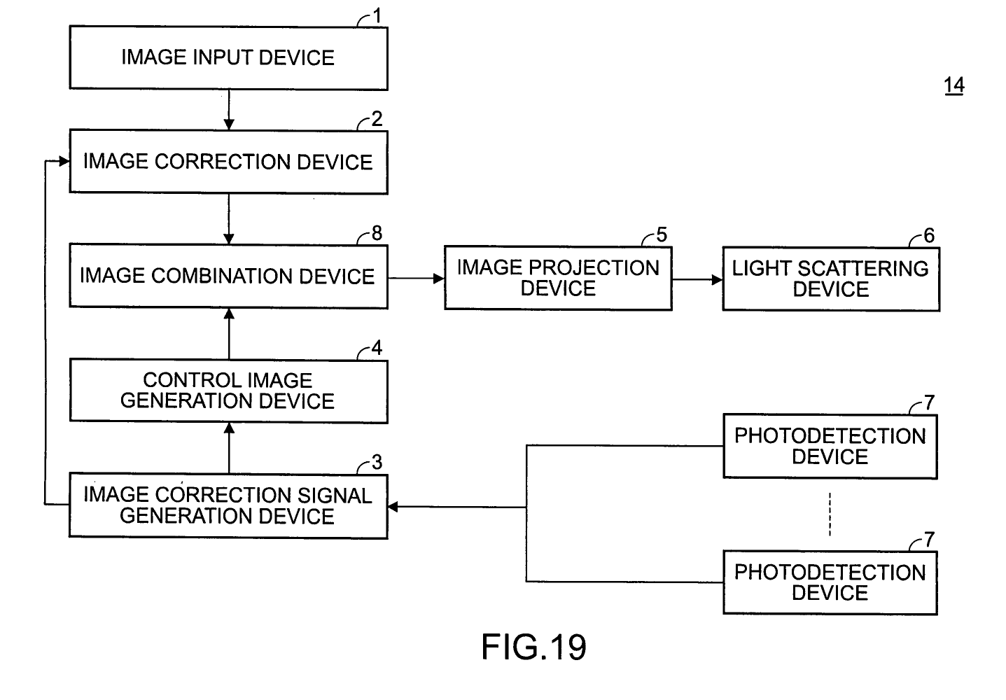

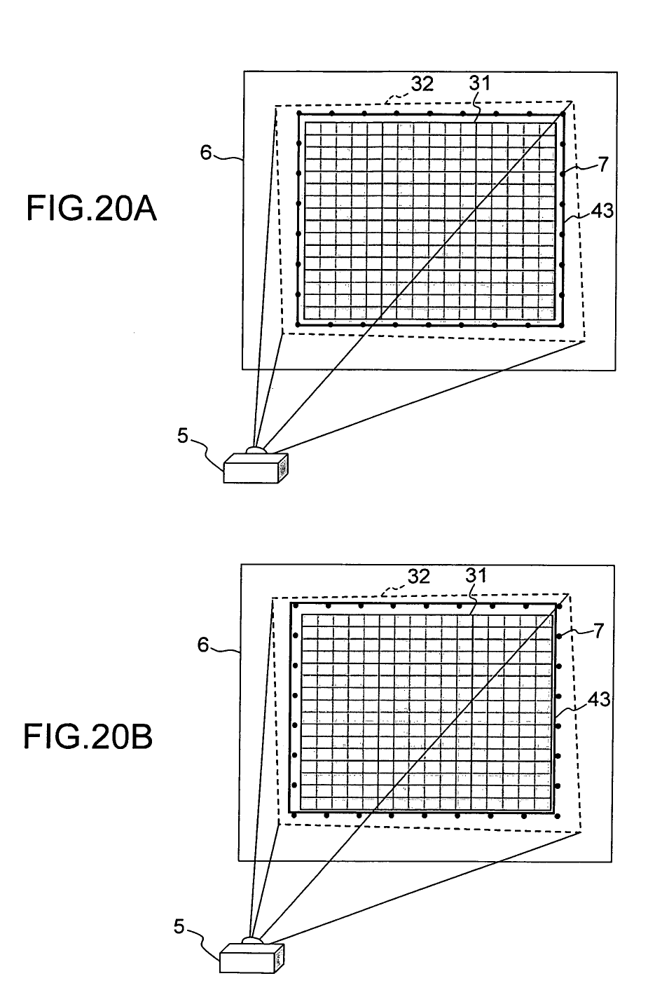

FIG. 19 is a schematic of the configuration of an image display apparatus 14 according to Exemplary Embodiment 3. FIGS. 20A and 20B are schematics of a projection image as projected on light scattering device 6. In FIG. 19, the same members as those of FIG. 1 are identified by like reference numerals and thus omitted from the detailed description.

As shown in FIG. 19, the image display apparatus 14 of Exemplary Embodiment 3 is different from the image display apparatus 10 of Exemplary Embodiment 1 in that its control image is a frame-like image and in that it includes the image combination device, but the other configuration thereof is the same as that of the image display apparatus 10 of Exemplary Embodiment 1.

In the image display apparatus 14 of Exemplary Embodiment 3, as shown in FIGS. 20A and 20B, a control image generation device 4 generates control image data on a frame-shaped control image (hereinafter called a frame-like image) 43, as control image data on a control image that is used to correct a display image to be projected onto the light scattering device 6.

Further, the image display apparatus 14 of Exemplary Embodiment 3 includes an image combination device 8. The image combination device 8 has the function of combining the control image data on the frame-like image 43 generated by the control image generation device 4 and display image data corrected by image correction device 2, and thus outputting the control image data and the display image data to four image projection devices 5.

In an image display method of Exemplary Embodiment 3, as shown in FIGS. 20A and 20B, the control image is the frame-like image 43 projected outside of the effective image display region 31, which therefore prevents the control image from being projected within the effective image display region. This makes it possible to detect a distortion of a projection image in real time resulting from displacement, etc. of the image projection device while projecting the projection image.

The aforesaid frame-like image 43 has a rectangular shape along the peripheral edge of the effective image display region 31. In the image display method of Exemplary Embodiment 3, the frame-like image 43 is projected on light scattering device 6 so as to be capable of being detected by all photodetection devices 7. As shown in FIG. 20A it is supposed that the state, in which the frame-like image 43 is detected by all the photodetection devices 7 and detection signals are outputted from all the photodetection devices 7, is the state in which a proper image correction is performed to the display image.

In contrast, as shown in FIG. 20B it is supposed that positional displacement has occurred in the image projection devices 5 and the projection position of the frame-like image 43 is displaced to prevent the detection signals from being outputted from the photodetection devices 7. This simultaneously means that positional displacement (distortion) occurs even in the display image displayed within the effective image display region 31 on the light scattering device 6. When positional displacement, etc. occur in the image projection devices 5, a proper image correction signal can be obtained by exerting control so that the frame-like image 43 can be detected again by all the photodetection devices 7 and then scanning the frame-like image 43. When this positional displacement is small, the configuration may be such as to scan only a specific portion outside the effective image display region 31.

As with the case of the image display apparatus 10 of Exemplary Embodiment 1, the image display apparatus 14 of Exemplary Embodiment 3 is an image display apparatus including one image projection devices 5. However, as with the case of the image display apparatus 12 of Exemplary Embodiment 2, it may be configured to be an image display apparatus including a plurality of image projection devices 5. In this case, as with the case of the image display apparatus 12 of Exemplary Embodiment 2, preferably, the photodetection devices 7 on the light scattering device 6 are disposed around an effective image display region 31′ of all the plurality of image projection devices 5. Additionally, the control image need not necessarily be the frame-like image but, for example, when the image projection devices 5 are disposed in two-by-two arrangement as with the case of image display apparatus 12 of Exemplary Embodiment 2, the control image can also be formed into an L shape that corresponds to adjacent two sides out of four sides of the rectangle.

### Exemplary Embodiment 4

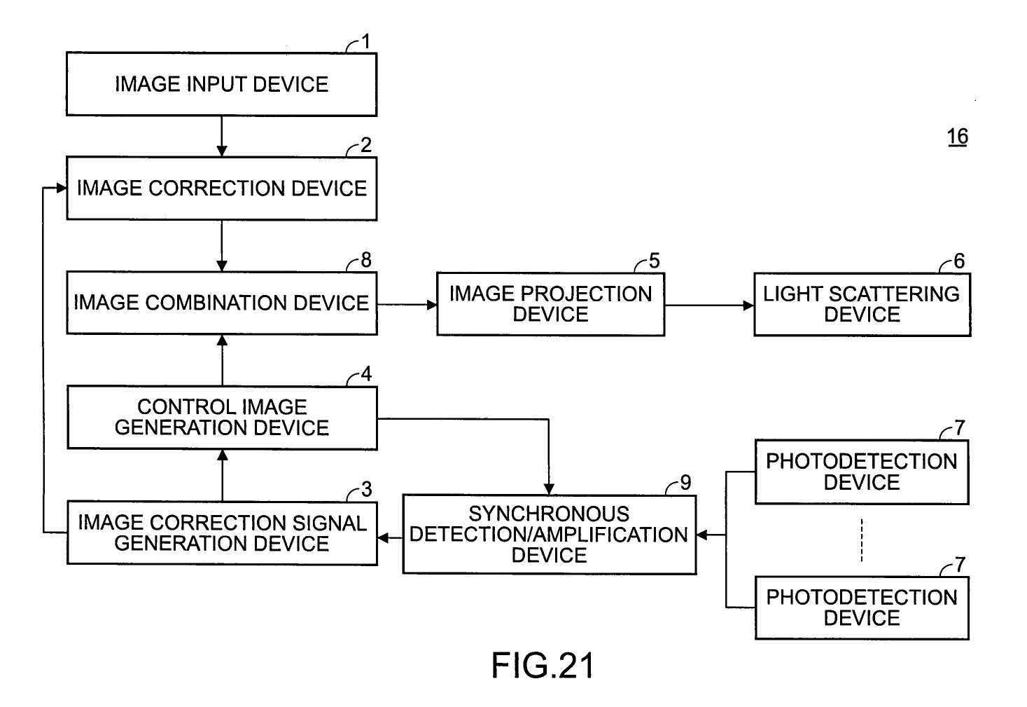

FIG. 21 is a schematic of the configuration of an image display apparatus 16 according to Exemplary Embodiment 4. In FIG. 21, the same members as those of FIG. 19 are identified by like reference numerals and thus omitted from the detailed description.

As shown in FIG. 21, the image display apparatus 16 of Exemplary Embodiment 4 is different from the image display apparatus 14 of Exemplary Embodiment 3 in that it further includes a lock-in amplification device, but the other configuration thereof is the same as that of the image display apparatus 14 of Exemplary Embodiment 3.

In the image display apparatus 14 of Exemplary Embodiment 3, for example, when the projection image and the control image are simultaneously projected onto the light scattering device 6, scattering light from the projection image sometimes occurs on the light scattering device 6. Therefore, there is a possibility that the control image is not properly detected as such scattering light is detected by the photodetection devices 7. In contrast, the image display apparatus 16 of Exemplary Embodiment 4 further includes a lock-in amplification device 9, thus making it possible to eliminate the influence of such scattering light.

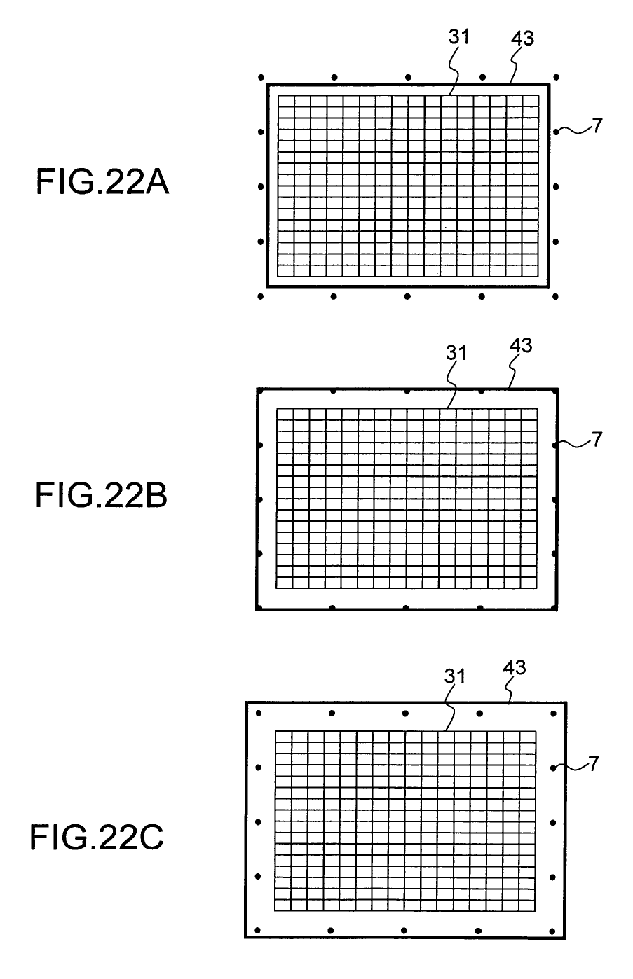

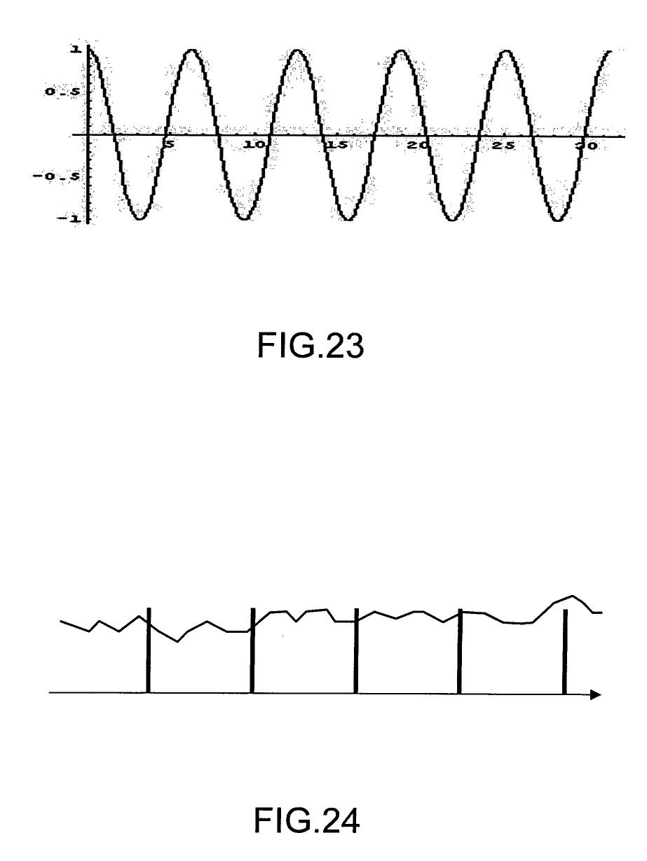

FIGS. 22A-22C are schematics of an image display method according to Exemplary Embodiment 4. FIG. 23 is a schematic of a reference signal for use in the image display method according to Exemplary Embodiment 4.

Unlike the image display method of Exemplary Embodiment 3, as shown in FIGS. 22A to 22C the image display method of Exemplary Embodiment 4 is characterized in that the position of a frame-like image 43 serving as the control image varies temporally. That is, the frame-like image 43 is modulated by the reference signal (which provides such a sinusoidal wave as shown in FIG. 23 in the image display method of Exemplary Embodiment 4). Thereby, the frame-like image 43 periodically repeats expansion and contraction and thus periodically passes over photodetection devices 7.

And, frame-like image 43 detection signals from the photodetection devices 7 and the reference signal are inputted to the lock-in amplification device 9, thereby amplifying only detection signals synchronous with the reference signal, out of the frame-like image 43 detection signals from the photodetection devices 7.

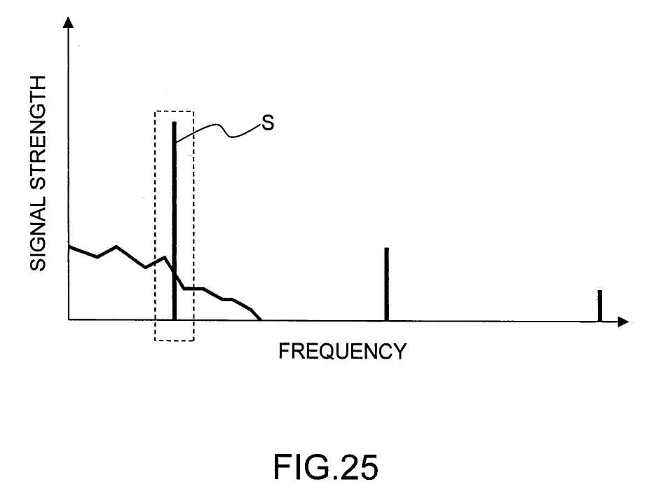

FIG. 24 is a schematic of the situation in which scattering light from a projection image is detected by the photodetection devices 7, as superimposed on the frame-image 43. The lock-in amplification device 9 multiplies such a signal as shown in this FIG. 24 by the reference signal (sinusoidal wave) shown in FIG. 23 and then integrates and amplifies the product. That is, this is equivalent to amplifying a specific frequency signal on a frequency scale. FIG. 25 is a schematic of the operation of amplifying the specific frequency signal on the frequency scale. In the example of FIG. 25, only a signal S in a portion surrounded by a dashed square will be amplified.

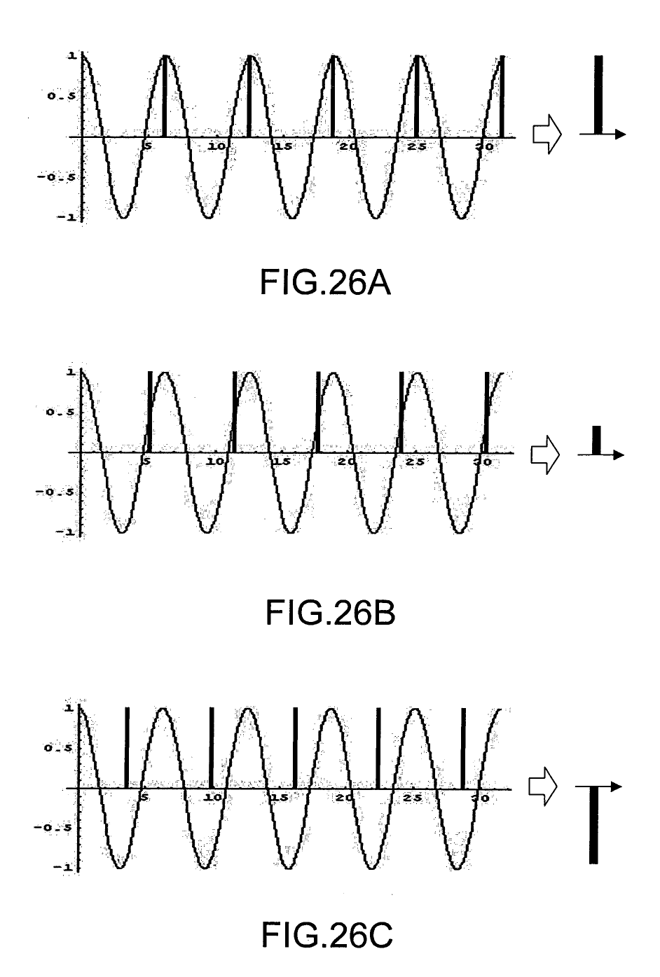

FIGS. 26A-26C are schematics of the principle of measuring the position of the photodetection devices 7, based on the operation of the lock-in amplification device 9. That is, the modulated frame-like image 43 can be made to correspond uniquely to the display position of the aforesaid frame-like image 43.

Accordingly, when the frame-like image 43 is detected by the photodetection devices 7 so as to correspond to the position of the positive peak of a sinusoidal wave as in FIG. 26A it turns out that the position of the aforesaid photodetection devices 7 is located close to an end portion of the modulated frame-like image 43. When a pulse is detected by the photodetection devices 7 at a position close to the origin of the sinusoidal wave as in FIG. 26B, it turns out that the position of the aforesaid photodetection devices 7 is located close to the center of the modulated frame-like image 43. When the frame-like image 43 is detected by the photodetection devices 7 at a position close to the negative peak of the sinusoidal wave as in FIG. 26C, it turns out that the aforesaid photodetection devices 7 is located close to an end portion of the frame-like image 43 opposite the end portion of FIG. 26A. Thus, it is possible to obtain the control image having minimized the influence of the scattering light from an effective image display region 31.

Thus, according to the image display method of Exemplary Embodiment 4, the control image can be detected, with high accuracy, without the photodetection devices 7 being influenced by the scattering light from the effective image display region 31. When proper control image detection signals can be obtained from the photodetection devices 7, an image correction signal can be generated using the detection signals.

As with the case of the image display apparatus 14 of Exemplary Embodiment 3, the image display apparatus 16 of Exemplary Embodiment 4 is an image display apparatus including one image projection devices 5. However, as with the case of the image display apparatus 12 of Exemplary Embodiment 2, the image display apparatus 16 of Exemplary Embodiment 4 can also provide an image display apparatus including a plurality of image projection devices 5. In this case, as with the case of the image display apparatus 12 of Exemplary Embodiment 2, the photodetection devices 7 on the light scattering device 6 are disposed around an effective image display region 31′ of all the plurality of image projection devices 5. Additionally, the control image need not necessarily be the frame-like image but, for example, when the image projection devices 5 are disposed in two-by-two arrangement as with the case of image display apparatus 12 of Exemplary Embodiment 2, the control image can also be formed into an L shape that corresponds to adjacent two sides out of four sides of the rectangle.

The exemplary embodiments are not limited to the aforesaid but can be modified and carried out in various modes without departing from the scope and spirit of the invention.

Further, with the image display program, which has described herein, the procedure of a process for realizing the image display program for use in the above-described image display apparatus, can also be created and recorded on a recording medium, such as a flexible disk, an optical disk, or a hard disk. Accordingly, the exemplary embodiments include the image display program and the recording medium having recorded therein this image display program. Further, the exemplary embodiments may be configured to obtain the image display program from a network.

What is claimed is:

1. An image display method in which a projection image projected from an image projection device is scattered by a light scattering device, thereby displaying a display image on the light scattering device, the method comprising:
projecting a control image, which is used to correct the display image to be projected onto the light scattering device, from the image projection device toward the light scattering device;
detecting the control image by a plurality of photodetection devices disposed outside an effective image display region on the light scattering device;
generating an image correction signal, based on control image detection signals from the photodetection devices; and
projecting onto the light scattering device the projection image corrected based on the image correction signal.

2. The image display method according to claim 1, further including disposing the photodetection devices along the peripheral edge of the effective image display region.

3. The image display method according to claim 1, further including disposing the photodetection devices in a plane with the light scattering device.

4. The image display method according to claim 1, the control image being a longitudinal linear image extending in a longitudinal direction and a lateral linear image extending in a lateral direction, the method further including:
scanning the longitudinal linear image along the lateral direction of the light scattering device, and scanning the lateral linear image along the longitudinal direction of the light scattering device.

5. The image display method according to claim 1, further including projecting the control image, which is a frame-like image, outside the effective image display region.

6. The image display method according to claim 5, further including simultaneously projecting the control image and the display image.

7. The image display method according to claim 5, the detecting the control image, including periodically changing the size of the control image by a predetermined reference signal, and synchronously detecting and amplifying the control image detection signals and the predetermined reference signal, thereby amplifying only a component synchronous with the reference signal out of the control image detection signals, thus detecting the control image.

8. An image display apparatus, comprising:
an image input device to input display image data on a display image to be projected;
an image projection device that projects a projection image in response to the display image data inputted to the image input device; and
a light scattering device that displays the display image by scattering the projection image projected from the image projection device;
a control image generation device that generates control image data on a control image that is used to correct the display image to be projected;
a plurality of photodetection devices that are disposed outside an effective image display region on the light scattering device;
an image correction signal generation device that generates an image correction signal, based on control image detection signals from the photodetection devices; and
an image correction device that corrects the display image to be projected onto the light scattering device, based on the image correction signal.

9. The image display apparatus according to claim 8, the image projection device including a plurality of image projection devices,
the image correction device having a function of correcting the display image projected by the individual image projection devices.

10. A light scattering device for use in the image display apparatus according to claim 8, the light scattering device comprising:
a plurality of photodetection devices outside the effective image display region.

11. An image display program embodied on a recording medium, the program for use with an image display apparatus, in which a projection image projected from an image projection device scattered by a light scattering device, displays a display image on the light scattering device, the program comprising:
a program for projecting a control image, which is used to correct the display image to be projected onto the light scattering device, from the image projection device toward the light scattering device;
a program for detecting the control image by a plurality of photodetection devices disposed outside an effective image display region on the light scattering device;
a program for generating an image correction signal, based on control image detection signals from the photodetection devices; and
a program for projecting onto the light scattering device the projection image corrected based on the image correction signal.
